(19) United States
(12) Patent Application Publication
(10) Pub. No.: US 2025/0383729 A1
(43) Pub. Date: Dec. 18, 2025

(54) DISPLAY APPARATUS WITH AN INTEGRATED TOUCH SCREEN

(71) Applicant: LG Display Co., Ltd., Seoul (KR)

(72) Inventors: Jusung PARK, Paju-si (KR); JeongHyun PARK, Paju-si (KR)

(73) Assignee: LG Display Co., Ltd., Seoul (KR)

(21) Appl. No.: 19/237,664

(22) Filed: Jun. 13, 2025

(30) Foreign Application Priority Data
Jun. 14, 2024 (KR) 10-2024-0077569

(51) Int. Cl. G06F 3/041

(52) U.S. Cl. CPC G06F 3/0412; G06F 3/0416; G06F 2203/04112

(57) ABSTRACT

An aspect of the present disclosure is directed to providing a touch screen integrated display apparatus that receives a user's input in place of a deleted button key in a bezel area. The display apparatus with an integrated touch screen can include a display area including a plurality of touch electrodes, a non-display area adjacent to the display area and including a bezel touch unit and a plurality of bezel wirings, and a touch driving unit configured to apply a touch driving signal to the plurality of touch electrodes. The touch driving unit applies the touch driving signal to the bezel touch unit through the plurality of bezel wirings in the non-display area.

### CROSS-REFERENCE TO RELATED APPLICATIONS

This application claims priority to Korean Patent Application No. 10-2024-0077569, filed on Jun. 14, 2024 in the Republic of Korea, which is hereby expressly incorporated by reference into the present application in its entirety.

### BACKGROUND

### Field of Technology

The present disclosure relates to a display apparatus with an integrated touch screen.

### Discussion of the Related Art

With the advent of the full-fledged information society, a display field for visually displaying electrical information signals has developed rapidly. Accordingly, research for improving performance such as thinning, lightening, and low power consumption for various display apparatuses is continuing.

In addition to televisions and monitors, these displays are widely used for displaying screens such as tablets, smartphones, portable computers, and portable information devices, and representative examples include Liquid Crystal Display (LCD) and Organic Light Emitting Display (OLED).

A tablet, a smartphone, a portable computer, a portable information device, or the like implemented as a display apparatus can implement an input interface for selecting an object or area displayed on the display surface in a touch manner. To this end, the display apparatus can be configured to have a structure in which a separate touch panel is attached to a display panel, a structure in which separate touch electrodes are formed in a display panel, or a structure in which any one of the components of a display panel is utilized as a touch electrode.

A display apparatus includes a display area in which an image is displayed and a bezel area that is an outer edge area of the display area, and a button key to allow the user to control the device can be provided in the bezel area. Although this button key is implemented in the form of recognizing the user's physical pressure, there can be a limit to reducing the width of the bezel area of the display apparatus due to the provision of the button key.

### SUMMARY OF THE DISCLOSURE

Accordingly, the present disclosure is directed to providing a light emitting display apparatus that substantially obviates one or more problems due to limitations and disadvantages of the related art.

An aspect of the present disclosure is directed to providing a touch screen integrated display apparatus including a new means for receiving a user's input in place of a deleted button key in a bezel area.

Additional advantages and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description as well as the appended drawings.

To achieve these and other advantages and in accordance with the purpose of the disclosure, as embodied and broadly described herein, there is provided a display apparatus with an integrated touch screen comprising a display area with a plurality of touch electrodes; a non-display area surrounding the display area and including a bezel touch unit and a plurality of bezel wirings; and a touch driving unit configured to apply a touch driving signal to the plurality of touch electrodes, wherein the touch driving unit applies the touch driving signal to the bezel touch unit through the plurality of bezel wirings in the non-display area. The bezel touch unit includes a plurality of bezel touch electrodes, and the plurality of bezel touch electrodes are the same material as the plurality of touch electrodes. The plurality of bezel touch electrodes is formed of a transparent electrode or an opaque metal mesh. A bezel printing pattern is formed in an area except the bezel touch unit in the non-display area and a touch icon pattern is formed in the bezel printing pattern of the bezel touch unit. The display area and the non-display area include a thin film transistor (TFT) substrate including a common electrode, a pixel electrode, and a TFT layer, a color filter substrate including a color filter layer and a black matrix, and a liquid crystal layer between the TFT substrate and the color filter substrate, and the bezel printing pattern is formed on one side of the TFT substrate. The black matrix exposes the color filter substrate in an area corresponding to the bezel touch unit. A multicolored pigment is patterned in an area where the color filter substrate is exposed by the black matrix. The plurality of bezel wirings and the bezel touch unit are formed on the other side of the TFT substrate. The display apparatus with an integrated touch screen further comprises an upper polarizing plate and a lower polarizing plate formed on outer surfaces of the TFT substrate and the color filter substrate, wherein one of the upper polarizing plate and the lower polarizing plate exposes a part of the TFT substrate or the color filter substrate in an area corresponding to the bezel touch unit. The display apparatus with an integrated touch screen further comprising: a first light source formed on a rear surface of the display area; and a second light source formed in an area corresponding to the bezel touch unit in the non-display area. The first light source and the second light source are different types. The display apparatus with an integrated touch screen further comprises a cover bottom formed under the TFT substrate and the color filter substrate, wherein the color filter substrate is provided between the cover bottom and the TFT substrate. The display apparatus with an integrated touch screen further comprises: a pad connected to the TFT substrate; and a circuit film connected to the pad and bent along a side of the color filter substrate to extend to the bottom of the color filter substrate. The cover bottom includes a side cover bottom, and the bezel touch unit in the bezel printing pattern is disposed on the side cover bottom.

It is to be understood that both the foregoing general description and the following detailed description of the present disclosure are example and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a diagram illustrating a display apparatus according to embodiments of the present disclosure;

FIG. 2A is a schematic diagram of a general display apparatus;

FIG. 2B is a diagram illustrating a cross-sectional surface of a bezel unit of the display apparatus of FIG. 2A;

FIG. 3A is a schematic diagram of a display apparatus according to embodiments of the present disclosure;

FIG. 3B is a diagram illustrating cross-sectional surfaces of a bezel unit of the display apparatus of FIG. 3A according to embodiments of the present disclosure;

FIG. 3C is an enlarged diagram of a display area portion C of the TFT substrate of FIG. 3B according to embodiments of the present disclosure;

FIG. 4 is a diagram illustrating a pixel structure of a display area of a display apparatus according to embodiments of the present disclosure;

FIGS. 5A and 5B are plane views of a bezel unit of the display apparatus illustrated in FIG. 3A according to embodiments of the present disclosure;

FIGS. 6A and 6B are diagrams illustrating a polarizing plate of a display apparatus according to embodiments of the present disclosure;

FIGS. 7A and 7B are diagrams illustrating a black matrix of a display apparatus according to embodiments of the present disclosure;

FIGS. 8A and 8B are diagrams illustrating a method of implementing an icon of a bezel touch unit of a display apparatus according to embodiments of the present disclosure;

FIGS. 9A and 9B are diagrams illustrating a bezel printing pattern of a display apparatus according to embodiments of the present disclosure;

FIG. 10A is a diagram illustrating a mechanical structure of a general display apparatus; and

FIG. 10B is a diagram illustrating a mechanical structure of a display apparatus according to embodiments of the present disclosure.

### DETAILED DESCRIPTION OF THE EMBODIMENTS

Reference will now be made in detail to the various embodiments of the present disclosure, examples of which are illustrated in the accompanying drawings. Wherever possible, the same reference numbers will be used throughout the drawings to refer to the same or like parts.

Advantages and features of the present disclosure, and implementation methods thereof will be clarified through following embodiments described with reference to the accompanying drawings. The present disclosure can, however, be embodied in different forms and should not be construed as limited to the embodiments set forth herein. Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted. When “comprise,” “have,” and “include” described in the present disclosure are used, another part can be added unless “only” is used. The terms of a singular form can include plural forms unless referred to the contrary.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts can be disposed between the two parts unless a more limiting term, such as “just” or “direct(ly)” is used.

In describing a time relationship, for example, when the temporal order is described as, for example, “after,” “subsequent,” “next,” and “before,” a case that is not continuous can be included unless a more limiting term, such as “just,” “immediate(ly),” or “direct(ly)” is used.

It will be understood that, although the terms “first,” “second,” etc. can be used herein to describe various elements, these elements should not be limited by these terms. These terms are only used to distinguish one element from another and may not define order of sequence. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” etc. can be used. These terms are intended to identify the corresponding elements from the other elements, and basis, order, or number of the corresponding elements should not be limited by these terms. The expression that an element is “connected,” “coupled,” or “adhered” to another element or layer should be understood the element or layer cannot only be directly connected or adhered to another element or layer, but also be indirectly connected or adhered to another element or layer with one or more intervening elements or layers “disposed,” or “interposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item. Also, the term “can” used herein includes all meanings and definitions of the term “may” and vice versa. Further, the term “means” can include, e.g., mechanism, structure, unit, module, circuit, device, apparatus, technology, operation, configuration, etc.

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in co-dependent relationship.

Hereinafter, embodiments of the present disclosure will be described in detail with reference to the accompanying drawings. All the components of each display apparatus according to all embodiments of the present disclosure are operatively coupled and configured.

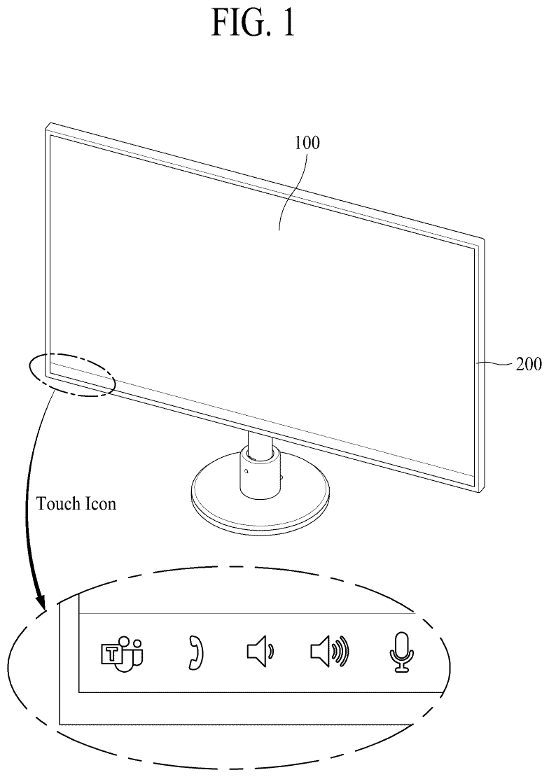

FIG. 1 is a diagram illustrating a display apparatus according to embodiments of the present disclosure.

Referring to FIG. 1, the display apparatus according to embodiments of the present disclosure includes a display area 100 and a non-display area 200.

The display area is an area in which an image is displayed, and the non-display area is an area adjacent to the display area, and may be an outer edge portion surrounding the display area and is a bezel area. Image information such as an image is not displayed in the non-display area.

An input means for controlling an input by a user can be provided in at least one corner or another partial area of the bezel area that is a non-display area. A user can perform basic operations for controlling the display apparatus as well as power on/off, sound control, brightness control, channel change, and the like of the display apparatus through the input means.

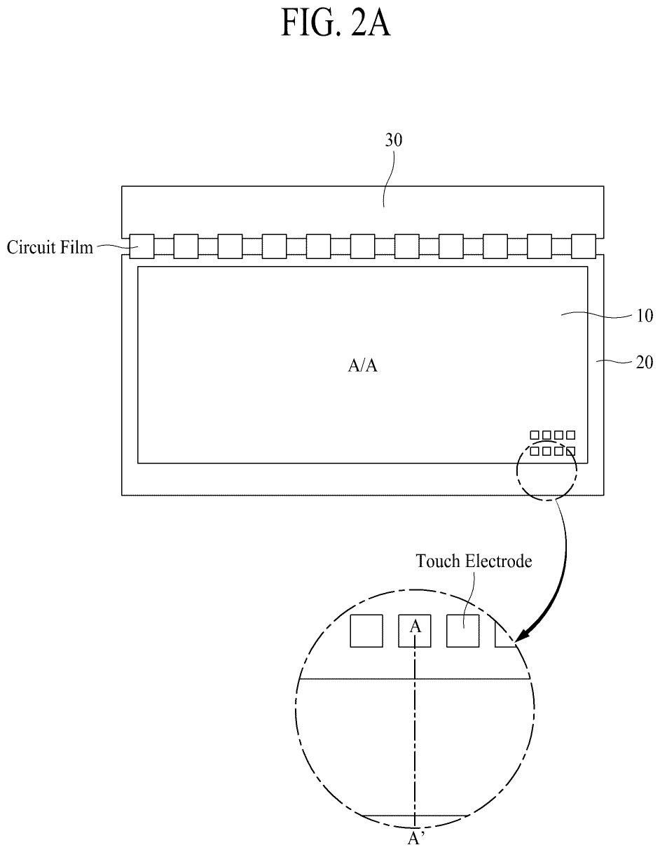

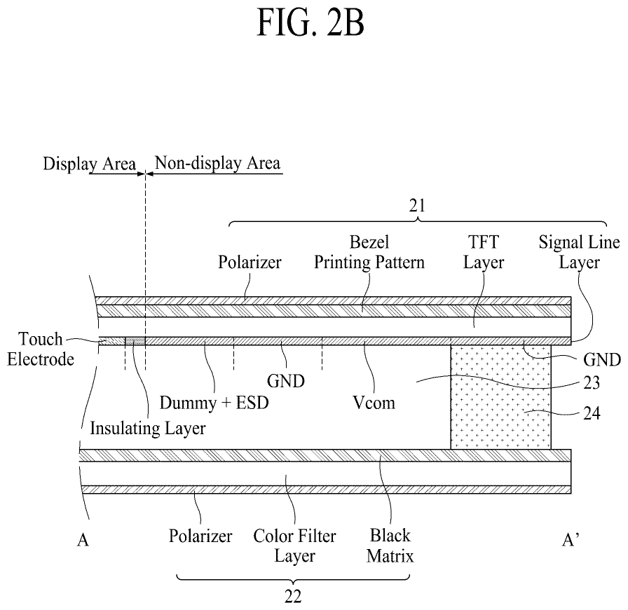

FIG. 2A is a schematic diagram of a general display apparatus and FIG. 2B is a diagram illustrating a cross-sectional surface of a bezel unit of the display apparatus of FIG. 2A.

Referring to FIG. 2A, the display apparatus includes a display panel unit divided into a display area 10 and a non-display area 20 and a driving integrated circuit 30 that is a driving unit of the display panel.

The display area (A/A or active area) 10 is an area in which an image is displayed, and an area in which a pixel array, in which a plurality of pixels are arranged in a matrix form, is disposed and pixel electrodes and common electrodes for driving the pixels are disposed. A plurality of gate lines and data lines for applying signals to pixels are disposed in the display area.

The non-display area 20 is a bezel area surrounding the display area, and circuit units such as a gate driving circuit, a data driving circuit, or the like can be connected to the non-display area or circuit components functioning as a driving circuit can be directly mounted or formed. In addition, a plurality of signal lines (dummy line, ESD line, GND line, and Vcom line) that transmit signals to the display area are disposed. In the non-display area 20 of the general display apparatus, physical buttons MENU, READER, FUNC, AUTO, and INPUT/Exit to allow a user to control a device can be provided as illustrated in FIG. 2A. In this button method, the user applies a physical force to the button to drive the button.

The driving unit of the panel is generally a gate driving circuit and/or a data driving circuit, but is not limited thereto, and can further include a touch driving circuit for sensing a user's touch input. Each of the above-described gate driving circuit, data driving circuit, and touch driving circuit can be one circuit, but the above-described gate driving circuit, data driving circuit, and touch driving circuit can be in the form of an integrated circuit that performs functions of two or more circuits in common.

FIG. 2B is a cross-sectional view taken along line A-A′ of FIG. 2A. Referring to FIG. 2B, a display panel of a general display apparatus is configured in a form in which a TFT substrate 21 and a color filter substrate 22 are combined with a liquid crystal layer interposed therebetween.

The TFT substrate 21 includes a signal wiring layer, a TFT layer, a bezel printing pattern, and an upper polarizing plate, and the color filter substrate 22 includes a black matrix, a color filter layer, and a lower polarizing plate. The TFT substrate 21 and the color filter substrate 22 are stacked with the liquid crystal layer 23 interposed therebetween. The signal wiring layer includes dummy wiring, ESD wiring, GND wiring, and Vcom wiring.

A sealant 24 is formed outside the substrate to bond the TFT substrate 21 and the color filter substrate 22 described above to each other.

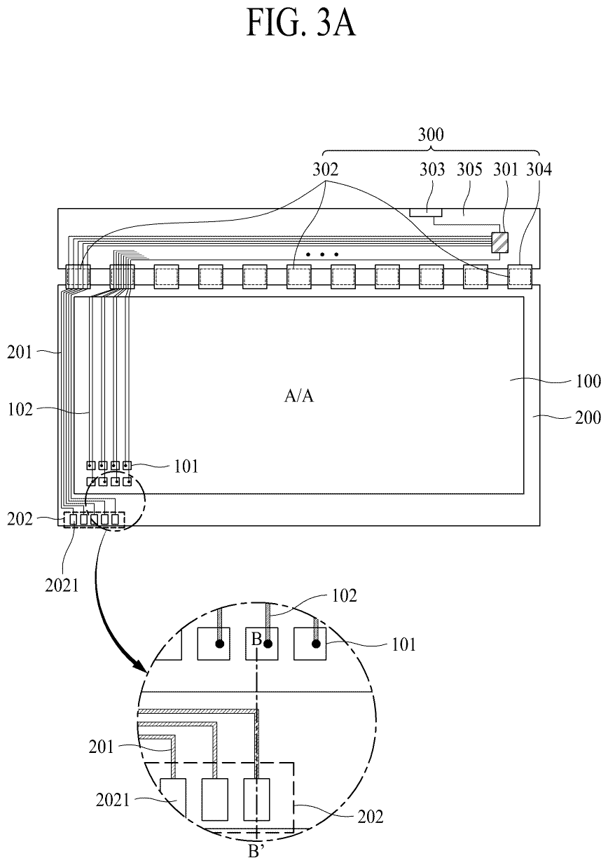

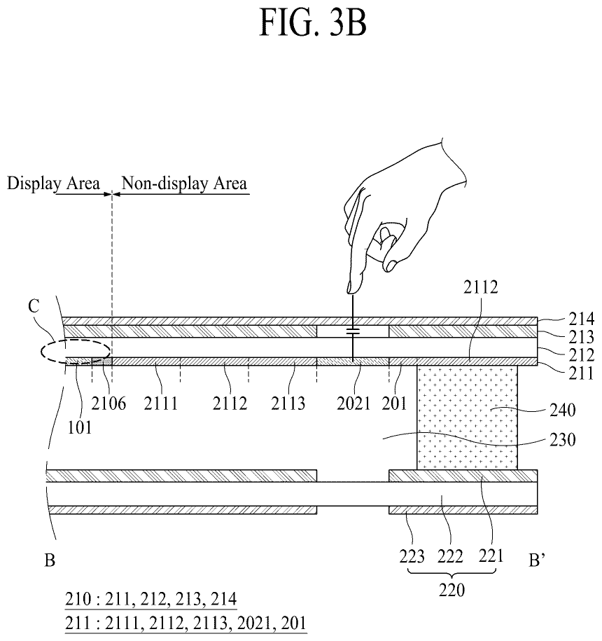

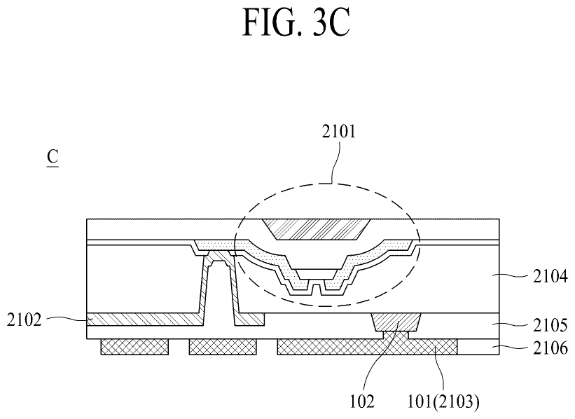

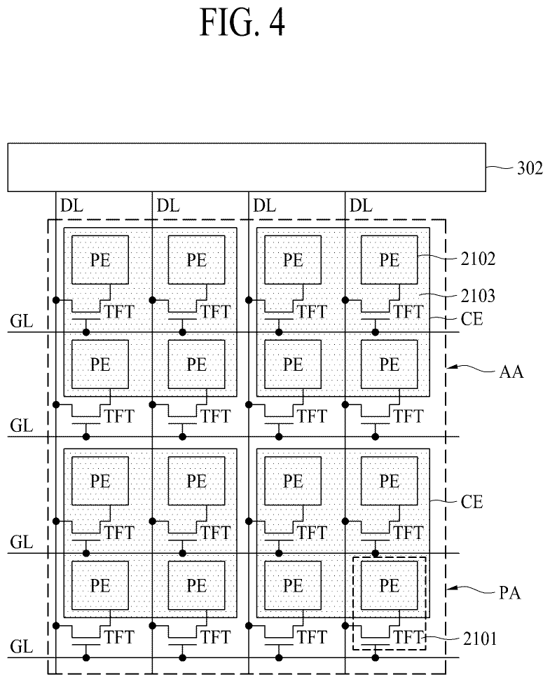

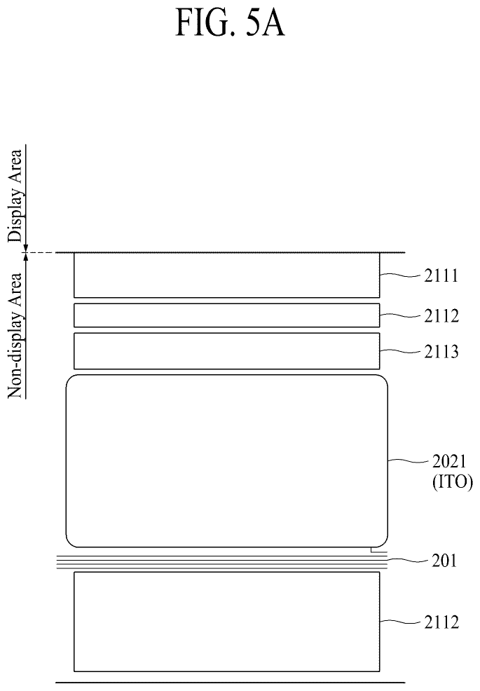

FIG. 3A is a schematic diagram of a display apparatus according to embodiments of the present disclosure, FIG. 3B is a diagram illustrating a cross-sectional surface of a bezel unit of the display apparatus of FIG. 3A, and FIG. 3C is an enlarged diagram of a display area portion C of the TFT substrate of FIG. 3B. FIG. 4 is a diagram illustrating a pixel structure of a display area of a display apparatus according to embodiments of the present disclosure. FIGS. 5A and 5B are plane views of a bezel unit of the display apparatus illustrated in FIG. 3A.

Hereinafter, various elements for pixel driving and touch driving among various elements included in the display area of the display apparatus will be described with reference to FIGS. 3A to 4.

The display apparatus according to embodiments of the present disclosure includes, as shown in FIG. 4, gate lines GL, data lines DL, and unit pixel areas PA defined by intersecting the gate lines GL and the data line DL. Also, the display apparatus further includes a pixel electrode (PE) 2102 allocated to the unit pixel area, and a common electrode (CE) 2103 corresponding to the pixel electrode 2102 and formed several times or tens of times larger than the pixel electrode 2102.

The pixel area PA includes a thin film transistor (TFT) 2101, which is a switching element, a storage capacitor, and a liquid crystal layer 230. A gate electrode of the thin film transistor 2101 is connected to a gate line GL, and a source electrode is connected to a data line DL. The storage capacitor has one end connected to a drain electrode of the thin film transistor 2101 and the other end connected to a Vcom wiring. The liquid crystal layer 230 is formed between a pixel electrode 2102 (PE) connected to the drain electrode of the thin film transistor 2101 and the common electrode 2103 (CE) connected to the Vcom wiring.

Here, the common electrode 2103 operates as an electrode forming liquid crystal capacitance with the pixel electrode 2102, and also operates as a touch electrode for touch sensing. In other words, when a driving mode of the display apparatus is a display driving mode, the common electrode 2103 functions as a common electrode, and when a driving mode of the display apparatus is a touch driving mode, the common electrode 2103 functions as a touch electrode. Because the common electrode according to embodiments of the present disclosure can also serve as a touch electrode for recognizing a touch, an effect of reducing the thickness of the display apparatus and improving durability can be obtained. The common electrode according to embodiments of the present disclosure also functions as a touch electrode, and the common electrode and the touch electrode refer to the same component in the present disclosure. Therefore, in the following description, even if the terms of the common electrode and the touch electrode are mixed, the common electrode and the touch electrode can be understood as the same component.

The display apparatus according to embodiments of the present disclosure is a touch screen integrated display apparatus of a self-capacitive type, but the present disclosure is not limited thereto. As shown in FIG. 3A, the touch electrodes 101 are connected in row or column units by a plurality of touch wirings 102, and simultaneously function as an element for implementing a display of the display apparatus and an element of a touch sensor for touch recognition. A touch electrode structure of a mutual-capacitive type touch screen has a grid structure including horizontal axes electrodes and vertical axes electrodes, and in the mutual-capacitive method, the change in capacitance occurring at the intersection is measured through the horizontal axes electrodes and the vertical axes electrodes. However, the self-capacitive method such as the present disclosure detects a touch by measuring a change in capacitance occurring between a single touch electrode and a user's finger or pen through a single touch electrode. In the self-capacitive method, each of the touch electrodes is connected to a respective touch wiring in a one-to-one manner. A touch wiring 102 serves to apply a touch driving signal of the touch driving circuit to a touch electrode and transmit a change in capacitance sensed by the touch electrode to the touch driving circuit.

Hereinafter, elements formed in the non-display area or capable of being connected to the non-display area will be described with reference to FIG. 3A.

Referring to FIG. 3A, a driving integrated circuit 300 is connected to the non-display area of a display apparatus of the present disclosure, and the driving integrated circuit includes a touch driving circuit 301, a data driving circuit 302, a timing controller 303, a circuit film 304, and a printed circuit board 305.

The driving integrated circuit 300 can be connected to a pad unit of a TFT substrate in the non-display area 200 of the display apparatus to transmit a signal so that an image corresponding to image data supplied from a driving system is displayed in each pixel. Although a touch driving circuit 301 is shown in a form mounted on a driving integrated circuit, the touch driving circuit 301 can also be separately disposed to be directly connected to the touch electrode of the display area through a pad unit. As described above, in the display apparatus according to embodiments of the present disclosure, the common electrodes also function as touch electrodes according to a driving mode, and the touch driving circuit 301 applies a touch driving signal to all or part of a plurality of common electrodes serving as touch electrodes in the touch driving mode. As shown in FIG. 3, a separate driving integrated circuit 300 including the touch driving circuit 301 can apply a touch driving signal to all or part of a plurality of electrodes serving as a touch electrode, or based on a driving circuit design method, a data driving circuit 302 including a function of the touch driving circuit or a gate driving circuit including a function of the touch driving circuit can apply a touch driving signal to a plurality of electrodes. In addition, the touch driving signal of the touch driving circuit 301 can be applied to a plurality of common electrodes serving as a touch electrode through the data driving circuit 302.

The touch driving circuit 301 senses the capacitance formed between the touch electrode and an input means such as a finger and a pen based on the touch driving signal applied to the touch electrodes. In other words, in the touch driving mode, the touch driving circuit 301 applies a touch driving signal to detect the presence or absence of a touch, a touch position, a touch movement, and a touch intensity, and performs an operation of detecting a touch sensing signal according to the applied touch driving signal. Also, the touch driving circuit 301 can apply a common voltage to the common electrode forming the liquid crystal capacitance with the pixel electrode during the display driving mode. For this driving, the touch driving circuit can include a switch or multiplexer for selectively applying the touch driving signal and the common voltage based on the driving mode. However, the present disclosure is not limited thereto. For example, the common voltage may be applied to the common electrode separately from the data driving circuit 302 during the display driving mode, and the touch driving circuit 301 is used to simply detect the touch by applying a touch sensing signal to the common electrode during the touch driving mode.

The data driving circuit 302 can be configured to be individually mounted on each of a plurality of circuit films 304. Each of the data driving circuits 302 can receive pixel data and a data control signal provided from the timing controller 303, convert the pixel data into an analog-type pixel data signal based on the data control signal, and supply the pixel data signal to a corresponding data line. In FIG. 3A, the illustration of the connection relationship between the data driving circuit and the timing controller is omitted. The data driving circuit includes hundreds to thousands of channels depending on the size and characteristics of the display apparatus. Also, the data driving circuit can apply or transmit the common voltage Vcom, the power signal VCC, and the ground voltage signal GND as well as the data signal using the channels. Particularly, in embodiments of the present disclosure, the bezel wiring 201, which will be described later, is also connected to the touch driving circuit 301 through a pin of a channel of the data driving circuit to transmit the touch driving signal to the bezel touch electrode. In this case, the bezel wiring 201 can use some remaining pins of the channel of the data driving circuit rather than using the entire channel of the data driving circuit. More specifically, even if there are 720 or 960 channels of the data driving circuit, only pins of a partial channel can be allocated to the bezel wiring in proportion to the number of the bezel touch electrodes 2021 or touch icons to be described later.

Although the data driving circuit 302 according to embodiments of the present disclosure is illustrated in a form in which the data driving circuit 302 is individually mounted in each of a plurality of circuit films 304, a single or a plurality of data driving circuits can be mounted on the printed circuit board 305. The timing controller 303 can be mounted on the printed circuit board 305, and can receive a timing synchronization signal and image data provide from the display driving system through a connector provided on the printed circuit board 305. The timing controller 303 can align the image data to be suitable for a pixel arrangement structure based on the timing synchronization signal to generate pixel data and provide the generated pixel data to the data driving circuit 302.

Additionally, the timing controller 303 can generate a data control signal and a gate control signal based on the timing synchronization signal, control the driving timing of the data driving circuit 302 through the data control signal, and control the driving timing of a gate driving signal to be described later through the gate control signal. Additionally, the timing controller can generate a touch control signal to control the driving timing of the touch driving circuit.

Input terminals of each of a plurality of circuit films 304 can be attached to the printed circuit board 305 by a film attachment process, and output terminals can be attached to the pad unit by a film attachment process. Each of the plurality of circuit films 304 can be implemented as a flexible circuit film to reduce a non-display area of the display apparatus. For example, the plurality of circuit films 304 can be formed of a tape carrier package (TCP) or a chip on flexible board (COF). In the case of COF, the data driving circuit 302 can be mounted on each of the plurality of circuit films 304, but the present disclosure is not limited thereto, and the touch driving circuit 301 or other circuits can also be mounted.

The printed circuit board 305 can mount the touch driving circuit 301, the timing controller 303, and the like, and can serve to transfer signal and power between circuit units constituting the driving integrated circuit 300. For example, the printed circuit board 305 can provide a signal and driving power supplied from the timing controller 303 for displaying an image in each pixel to the data driving circuit 302. To this end, signal transmission lines and various power lines can be provided on the printed circuit board 305.

In a display apparatus according to embodiments of the present disclosure, instead of configuring a gate driving circuit, some circuits that can function as a gate driving circuit are formed together when manufacturing a thin film transistor as a switching element, and are connected to a plurality of gate lines provided in the display area. The gate driving circuit generates a gate driving signal according to a predetermined order based on the gate control signal supplied from the timing controller 303 and supplies the gate driving signal to the gate line. Instead of configuring the gate driving circuit separately, by configuring the gate driving circuit as a gate-in-panel (GIP) type in which the remaining circuit of the gate driving circuit and the data driving circuit are integrated into one and mounted only on one side of the display apparatus, the volume and weight of the display apparatus can be reduced compared to the configuration in which the gate driving circuit is mounted on the driving integrated circuit 300 or the gate driving circuit is connected to the display area through the pad unit. However, the configuration of the gate driving circuit of the present disclosure is not limited to the GIP type.

The display apparatus of the present disclosure can include a power supply that generates signals such as a common voltage (Vcom), a power signal (VCC), and a ground voltage signal (GND) as a circuit unit, and the power supply unit can be mounted in the driving integrated circuit or can be configured as a separate component.

Also, an interface unit, various types of signal wirings and the like are located in the non-display area of the display apparatus of the present disclosure. The interface unit includes a plurality of connection pads and pins connected to the wirings extending to the display area, and the signal wirings include ESD wiring 2111, GND wiring 2112, Vcom wiring 2113 and the like.

The ESD wiring 2111 is formed to protect wirings of a pad unit and a display area from an external ESD. The GND wiring 2112 forms a reference potential (for example, a ground voltage), and at the same time, serves to discharge a voltage induced by a high voltage to the outside of a circuit board, and the Vcom wiring 2113 serves to transmit a common voltage Vcom to a common electrode.

The signal wirings of the present disclosure further include a bezel wiring 201. Here, the bezel wiring performs the same function as the touch wiring. However, the bezel wiring connected to the touch driving circuit does not overlap the touch electrode and extends along the bezel unit of the non-display area. In particular, the bezel wiring can be formed in the bezel unit by being connected to pins of some channels of the data driving circuit 302. The touch wiring in the display area transmits both the common voltage and the touch driving signal. However, because a bezel touch unit, which will be described later, does not drive a pixel, the bezel wiring in the non-display area serves to transmit only the touch driving signal, not the common voltage. However, when the purpose of using the bezel touch unit is changed or a function of the bezel touch unit is added, a configuration of transmitting a common voltage is sufficiently possible. The bezel wiring can be formed between other signal wirings to reduce an interference with other image driving signals, but can be formed at the outermost side depending on signal influence. The number of bezel wirings can be formed in proportion to the number of touch icons implemented by using the bezel touch electrode 2021 of the bezel touch unit. For example, when there are five touch icons, the bezel wiring can be formed as 5, 10, or more.

The plurality of bezel wirings 201 described above are connected to the bezel touch unit 202 which is a device input control means of a user in at least one corner or a specific area of the bezel area. Here, the bezel touch unit 202 includes a plurality of bezel touch electrodes 2021. In other words, the plurality of bezel wirings 201 are connected to the plurality of bezel touch electrodes 2021 of the bezel touch unit 202 respectively to apply a touch driving signal of the touch driving circuit 301 to the bezel touch electrode 2021, and transmit a change in capacitance according to the applied touch driving signal to the touch driving circuit 301 again. For example, the bezel touch electrode 2021 performs a function for controlling an input by a user through a touch driving signal from the touch driving circuit 301 in the same driving method as the touch electrodes 101 in the display area. However, the bezel touch electrode differs in that the bezel touch electrode does not function as an electrode for driving pixels and only performs a touch sensing function. In this case, the bezel touch electrode does not receive a common voltage, and only a touch driving signal can be continuously applied to the bezel touch electrode regardless of the mode of the display apparatus. The bezel touch electrode can be formed to have the same size as the touch electrode, but if there is an advantage of design, the bezel touch electrode can be formed to have a smaller size than the touch electrode. In addition, the bezel touch electrode can have a circular, elliptical, or triangular shape as well as a square shape depending on the shape of the touch icon to be implemented through the bezel touch unit, but the shapes and sizes of these bezel touch electrodes are not limited thereto.

FIG. 3B is a cross-sectional view taken along line B-B′ of FIG. 3A. Hereinafter, a stacked form and a cross-sectional structure of a TFT substrate and a color filter substrate will be described in detail with reference to a cross-sectional view of a non-display area of a display apparatus according to embodiments of the present disclosure.

Referring to FIG. 3B, the TFT substrate 210 includes one or more of a signal wiring layer 211, a TFT layer 212, a bezel printing pattern 213, and an upper polarizing plate 214, and the color filter substrate 220 includes one or more of a black matrix 221, a color filter layer 222, and a lower polarizing plate 223.

The TFT substrate 210 and the color filter substrate 220 are stacked with a liquid crystal layer 230 interposed therebetween. In FIG. 3B, although the TFT substrate and the color filter substrate have the same size, the TFT substrate 210 can be formed to be larger than the color filter substrate because a pad unit for mounting a pad is required to be included in the TFT substrate 210.

The display apparatus is implemented in Twisted Nematic (TN) mode, Vertical Alignment (VA) mode, In-Plane Switching (IPS) mode, Fringe Field Switching (FFS) mode, or Electrically Controlled Birefringence (ECB) mode depending on the structure of the pixel electrode and the common electrode.

A sealant 240 is formed outside the substrates to bond the TFT substrate 210 and the color filter substrate 220 to each other, and the sealant serves to maintain the cell gap and maintain the stability and reliability of the liquid crystal layer.

The TFT layer 212 of the TFT substrate 210 will be described with reference to FIG. 3C. FIG. 3C is an enlarged diagram of a display area portion C of the TFT substrate of FIG. 3B.

Referring to FIG. 3C, the TFT layer 212 of the present disclosure includes a thin film transistor 2101, a pixel electrode 2102, touch electrodes 101 or 2103, and a plurality of protective layers 2104, 2105, and 2106.

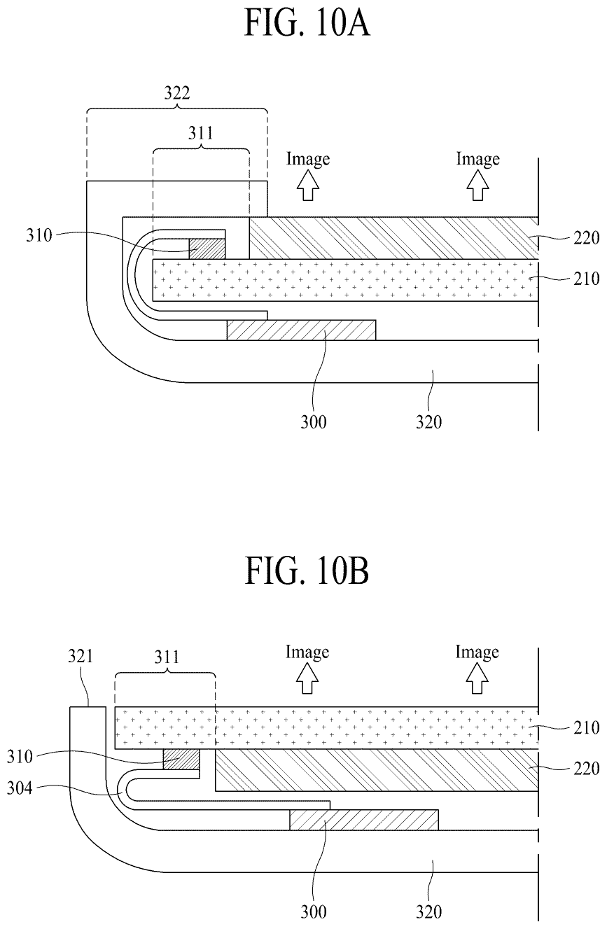

The thin film transistor 2101 is formed as a switching element in a display area of a display apparatus, and includes a gate electrode, a gate insulating layer, an active layer, a source electrode, a drain electrode, an etch stopper, and the like. Here, the gate electrode can serve to protect the active layer, the source electrode, and the drain electrode under the gate electrode in the flip design structure such as the present disclosure. The flip design structure will be described with reference to FIG. 10 to be described below. The pixel electrode 2102 is formed on a first protective layer 2104, and is connected to the drain electrode through a contact hole exposing the drain electrode. The pixel electrode 2102 is used as an electrode for driving a display apparatus, and can be formed of a transparent conductor such as an indium tin oxide (ITO).

The touch wiring 102 is formed on the first protective layer 2104 to be spaced apart from the pixel electrode 2102. The touch wiring 102 applies a display driving signal and a touch driving signal to the touch electrode 101. The second protective layer 2105 is formed on the first protective layer 2104 to insulate the pixel electrode 2102 and the touch electrode 101 from each other. The touch electrode 101 or 2103 is formed on the second protective layer 2105, and is connected to the touch wiring 102 through a contact hole of the second protective layer 2105. The touch electrode can include a slit. The third protective layer 2016 is formed to insulate or separate each of a plurality of touch electrodes from each other. The third protective layer can also be formed on a plurality of touch electrodes. The structure of the TFT layer described above shows a Vcom Top structure in which the touch electrode is formed above the pixel electrode with respect to the thin film transistor, but the present disclosure is not limited thereto. For example, the structure of the TFT layer can also be formed in a Pixel Top structure in which the pixel electrode is formed above the common electrode. Also, FIG. 3C illustrates a structure in which the touch wiring is connected to the touch electrode through a contact hole, but the present disclosure is not limited thereto, and thus any structure can be possible as long as the touch wiring and the touch electrode are connected within the TFT layer. In addition, as shown in FIG. 3A, a plurality of bezel touch electrode corresponding to the number of the touch icons are sequentially arranged in one direction (for example, a width direction of the display apparatus) and electrically separated from each other and connected to the plurality of bezel wirings respectively. Also, the bezel touch unit as well as the touch icons may not be disposed at a lower side of the display apparatus, and may also be disposed at a left side, a right side and/or an upper side of the display apparatus.

According to FIGS. 5A and 5B which is a plan view of the bezel unit of the display apparatus shown in FIG. 3B, the signal wiring layer 211 is a layer in which various types of signal wirings such as the ESD wiring 21111, GND wiring 2112, Vcom wiring 2113, and bezel wiring 201 and the bezel touch electrode 2021 are formed. Here, the signal wiring layer refers only to the configuration of the non-display area and does not include elements of the display area such as the touch electrode. Although it is shown in FIGS. 5A and 5B that the ESD wiring 21111, a first portion of the GND wiring 2112, the Vcom wiring 2113, the bezel touch electrode 2021, the bezel wiring 201 and a second portion of the GND wiring 2112 are sequentially arranged in a direction from the display area to the non-display area, the present disclosure is not limited thereto, and the arrangement order of these wirings or electrodes may be changed when necessary and one or more of these wirings or electrodes may be omitted.

The bezel wiring 201 and the bezel touch electrode 2021 are connected to each other in a one-to-one manner in the non-display area. The bezel wiring 201 is disposed on the non-display area and extends to the bezel touch unit 202 in the non-display area through one bezel. A configuration in which the bezel wiring 201 is formed across the display area can be considered, but in this case, it can be inevitable to change the touch driving circuit 301 or the data driving circuit 302. The reason is that a touch electrode 101 receives both a common voltage and a touch driving signal by performing a display driving and a touch driving in a time division manner, but the bezel touch electrode 2021 receives only a touch driving signal. When the bezel wiring is formed in the non-display area, the bezel wiring can be configured to be connected to the touch driving circuit through a remaining pin of the channels of the outermost data driving circuit to receive only the touch driving signal. However, when the bezel wiring is formed across the display area, all the pins of the data driving circuit formed inside can be connected to the touch electrode 101, and thus there can be no pins to be connected to the bezel touch electrode 2021, or it is not easy to connect the bezel wiring and the touch driving circuit, and thus the configuration of some touch driving circuits 301 or data driving circuits 302 can have to be changed.

The bezel wiring 201 and the bezel touch electrode 2021 can be formed on the same plane, but are not limited thereto. The bezel touch electrode 2021 is formed on the same plane as the touch electrode 101 in the display area. The bezel touch electrode 2021 and the touch electrode 101 can be formed by the same process. Also, the bezel touch electrode 2021 is made of the same material as the touch electrode.

A plurality of bezel wirings 201 apply a touch driving signal to the bezel touch electrode 2021 of the bezel touch unit 2022, and transmit a change in capacitance of the bezel touch electrode 2021 based on the applied touch driving signal to the touch driving circuit again. The bezel touch electrode 2021 performs a function for controlling a user's input in the non-display area 200 in a self-capacitance method that is the same driving method as the touch electrodes 101 in the display area, but the present disclosure is not limited thereto.

The bezel touch electrode 2021 of the bezel touch unit 202 is provided in at least one corner or another partial area of the bezel area, which is the non-display area 200, and performs a function of a touch input unit capable of performing basic operations for controlling the display apparatus as well as power on/off, sound control, brightness control, and channel change.

Here, the bezel touch unit 202 and the bezel touch electrode 2021 included in the bezel touch unit 202 are not configured in the form of a physical button, but in the form of a touch icon displayed in the display apparatus. As a result, a narrow bezel can be achieved through a structure in which a physical button key is removed from the non-display area, and the aesthetics of the display apparatus can be improved. In addition, it is possible to increase the usability of the area by adding a touch function to the bezel area, which is an unused area. Also, the touch sensing sensitivity of the display apparatus using the touch icon compared to the physical button can be increased, and feedback on device input control can be accelerated.

The bezel touch electrode 2021 can have the same square shape as the touch electrode, but is not limited thereto. In addition, as shown in FIG. 5A, the bezel touch electrode can be made of a transparent conductive material (ITO) so that a touch input unit or a touch icon can be displayed or exposed to the outside. Alternatively, as shown in FIG. 5B, the bezel touch electrode can be made of opaque metal. In this case, the bezel touch electrode 2021 can be implemented in the form of a metal mesh to be configured not to interfere with the display function as much as possible.

As shown in FIG. 3B, the bezel printing pattern 213 can be formed in the non-display area (or bezel area) that is the circumference of the display area, substantially forms the edge of the display area, and serves to prevent or reduce light leakage by a light source located on the rear surface of the display area for driving the display. The bezel printing pattern 213 is usually made of a black border, but is not limited thereto as long as it is a color or design for realizing the original function of the bezel printing pattern. The readability or immersion of the screen can be increased by the bezel printing pattern. The bezel printing pattern 213 can be formed by a screen-printing method on tempered glass or an inkjet printing method on a plastic film. Typically, the bezel printing pattern is printed to a thickness of 1 μm to 30 μm. The bezel printing pattern 213 according to embodiments of the present disclosure can be printed to be formed without an exposed portion in a non-display area, but can include an open portion or be patterned to have an open portion in the bezel touch area. In other words, the bezel printing pattern 213 can be patterned in an area corresponding to the bezel touch unit 202 and the bezel touch electrode 2021 constituting the bezel touch unit 202 to facilitate the function execution of the bezel touch unit 202 and to display a touch icon of the bezel touch unit.

The color filter substrate 220 can include a black matrix 221, a color filter layer 222, and a lower polarizing plate 223, as shown in FIG. 3B. The black matrix 221 is made of an opaque metal or black resin, and serves to obviate or prevent image quality from being deteriorated due to the transmission of light to an area in which at least one of a thin film transistor, a gate line, and a data line is formed. In the color filter layer 222, red (R), green (G), and blue (B) color filters are formed to realize actual colors. A planarization layer can be formed on the color filter layer 222.

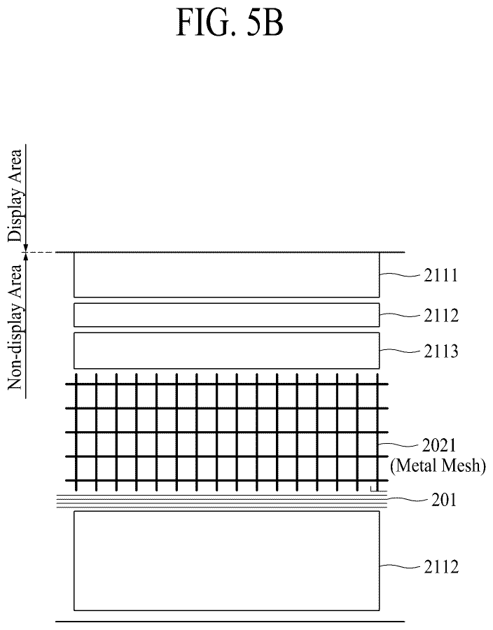

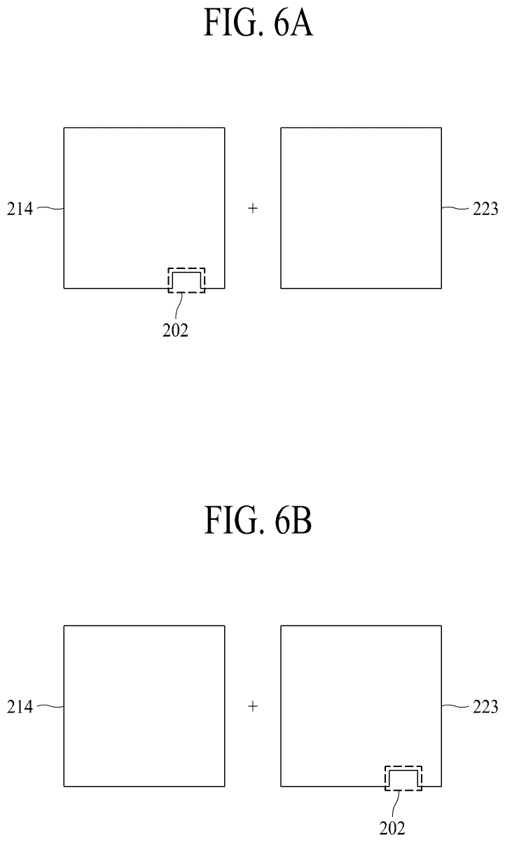

FIGS. 6A and 6B are diagrams illustrating a polarizing plate of a display apparatus according to embodiments of the present disclosure. Hereinafter, the structure of the polarizing plate, the black matrix, and the bezel printing pattern according to embodiments of the present disclosure will be described with reference to FIGS. 3B and 6A to 9B. The above-described elements are characterized in that they are patterned in a certain form in an area corresponding to the bezel touch unit or are formed in a structure that exposes the TFT substrate or the color filter substrate.

The upper polarizing plate 214 and the lower polarizing plate 223 are provided on both sides of a display panel including a TFT substrate 210, a color filter substrate 220, and a liquid crystal layer 230 filled therebetween, as shown in FIG. 3B, and function to polarize light supplied from a light source on a rear surface of the display panel in one direction. In more detail, the lower polarizing plate polarizes light incident from a light source, and the upper polarizing plate polarizes light passing through the display panel. The polarizing plate can further include a conductive pattern for collecting static electricity. The pattern directions of the two polarizing plates can be arranged perpendicular to each other to block wavelengths of incident light vibrating in different directions.

A part of any one of the polarizing plates can be formed by patterning an area to transmit light, as shown in FIGS. 6A and 6B, which is a diagram illustrating a polarizing plate according to one embodiment of the present disclosure. In particular, a part of the polarizing plate at an area corresponding to the bezel touch unit 202 can be patterned to form an open portion. Accordingly, a touch icon to be formed on the bezel touch unit 202 can be exposed, and an effect of increasing sensing sensitivity of the bezel touch electrode for a user's touch input can be obtained. If the aesthetics of the display apparatus design and the utility of the bezel touch unit function are considered, a structure in which the lower polarizing plate 223 is patterned rather than the upper polarizing plate 214 can be applied.

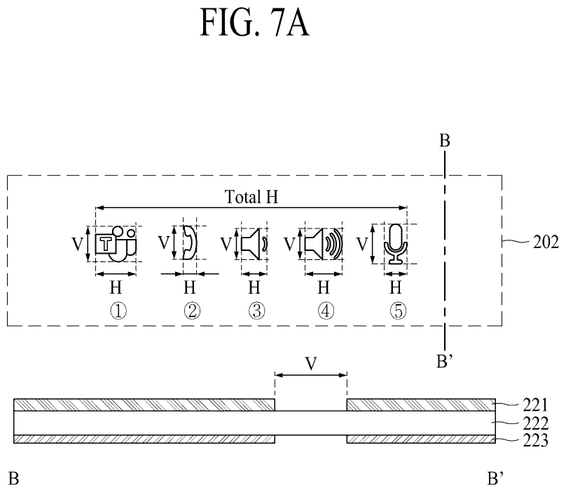

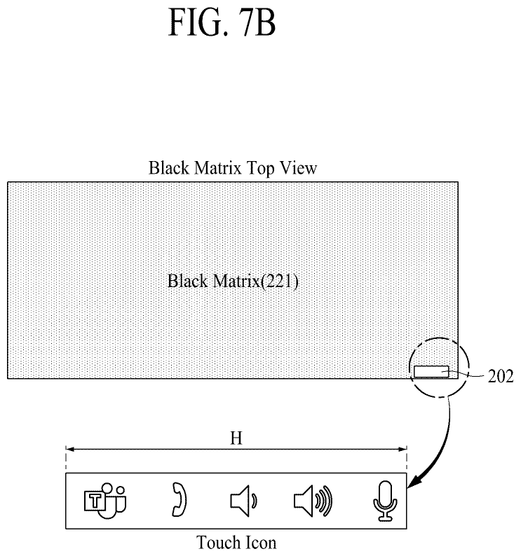

FIGS. 7A and 7B are diagrams illustrating a black matrix of a display apparatus according to embodiments of the present disclosure.

The bezel touch unit 202 of FIG. 7A includes a plurality of touch icons for each function, and the bezel touch electrode of the bezel touch unit is formed under each touch icon. As shown in the cross-sectional surface of B-B′, the black matrix 221 is formed to expose the color filter substrate 222 in an area corresponding to the bezel touch unit 202. In more detail, as shown in FIG. 7B, the black matrix of each touch icon portion of the bezel touch unit can be patterned or opened to apply light to the touch icon. Here, the pattern of the black matrix can be formed in a rectangular shape or other various shapes corresponding to the shape of the bezel touch unit rather than in a specific shape pattern such as the shape of the touch icon to form an open portion. In this case, the size of the open portion of the black matrix area is wider than the sum of the horizontal width H of each touch icon and longer than the vertical length V of the largest touch icon. The black matrix can be formed in the non-display area except for the patterned portion of the bezel touch unit.

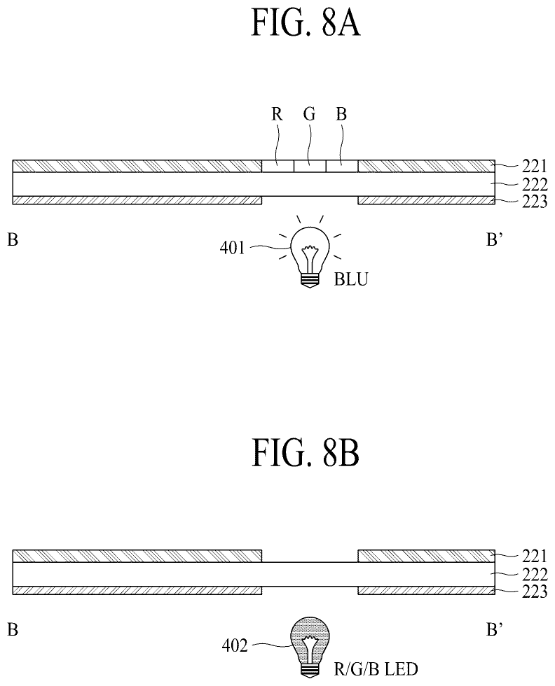

Hereinafter, a method of implementing a touch icon of a bezel touch unit using the black matrix will be described with reference to FIGS. 8A and 8B. FIGS. 8A and 8B are diagrams illustrating a method of implementing an icon of a bezel touch unit of a display apparatus according to embodiments of the present disclosure. As described above, the color filter substrate 220 includes a black matrix 221, a color filter layer 222, and a lower polarizing plate 223, and the black matrix 221 and the lower polarizing plate 223 are formed to expose or pattern a portion of the color filter substrate in an area corresponding to the bezel touch unit, and a light source is disposed under the color filter substrate.

The light source described through FIGS. 8A and 8B can be a light source formed in the display area and operated for image driving on the display panel, or can be a light source formed separately in the non-display area and used only for the purpose of implementing the touch icon of the bezel touch unit. In an area corresponding to the bezel touch unit, the light of the light source is directly applied to the color filter layer 222 without passing through the lower polarizing plate. In FIG. 8A, an example including a back-light unit (BLU) 401 using a white light source is illustrated, and the light of the light source passes through the color filter substrate, passes through the multicolored pigment patterned with a red/green/blue (R/G/B) color, or the like, and is applied to the bezel printing pattern to be described later. In this case, because the color of the light of the light source is changed according to the patterned pigment color of the black matrix 221, the color of the touch icon to be displayed through the bezel printing pattern can be implemented by adjusting the pigment pattern. In FIG. 8B, an example in which the light source includes an R/G/B LED 402 is illustrated, and the light of the light source is directly applied to the bezel printing pattern through the color filter substrate without passing through the black matrix 221 and the multicolored pigment. In this case, the color of the touch icon to be displayed through the bezel printing pattern can be implemented by adjusting the color of the R/G/B LED. When an R/G/B LED is used, white light can also be expressed by mixing three lights of red, green, and blue.

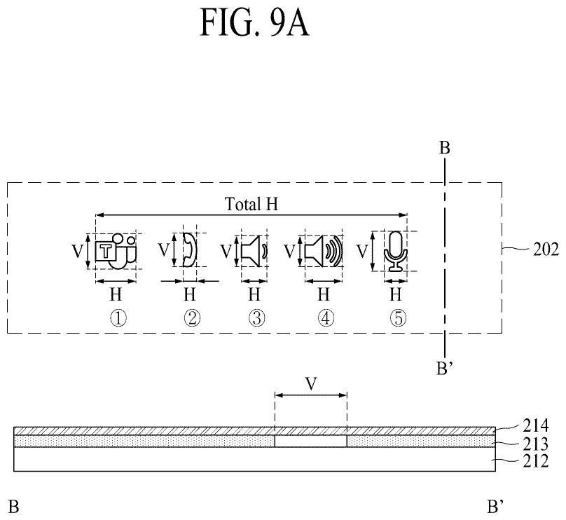

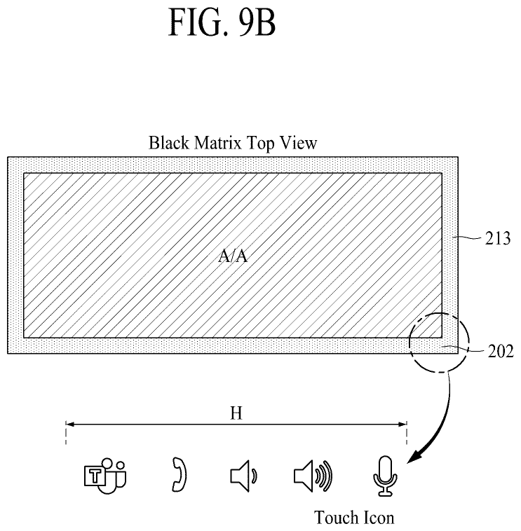

FIGS. 9A and 9B are diagrams illustrating a bezel printing pattern of a display apparatus according to embodiments of the present disclosure.

The bezel touch unit 202 of FIG. 9A includes a plurality of touch icons for each function, and the bezel touch electrode is formed under each touch icon. As shown in the cross-sectional surface of B-B′, the bezel printing pattern 213 is formed to expose the TFT substrate 212 in the area corresponding to the bezel touch unit 202. In more detail, as shown in FIG. 9B, a touch icon can be implemented by patterning the bezel printing pattern depending on the shape of each touch icon of the bezel touch unit. In other words, light transmitted through the open portion of the above-described black matrix passes through the bezel printing pattern 213 patterned in the form of a desired touch icon, and displays the touch icon in the bezel touch unit in the non-display area. Here, if the black matrix 221 has a structure that opens the entire bezel touch unit like a patterning form of the polarizing plate, the bezel printing pattern 213 does not have a structure that opens the entire bezel touch unit, and can be patterned to express a touch icon shape, which is included in the bezel touch unit, or an image corresponding thereto.

In this time, the size of the patterned bezel printing pattern 213 is wider than the sum of the horizontal width H of each touch icon and longer than the vertical length V of the largest touch icon. The bezel printing pattern is formed in the bezel area of the non-display area, and can include the open portion corresponding to the bezel touch unit.

Hereinafter, a mechanical structure of a display apparatus according to embodiments of the present disclosure will be described with reference to FIGS. 10A and 10B. FIG. 10A is a diagram illustrating a mechanical structure of a general display apparatus, and FIG. 10B is a diagram illustrating a mechanical structure of a display apparatus according to embodiments of the present disclosure.

The display apparatus of the present disclosure has a flip design structure in which a color filter substrate and a TFT substrate are vertically inverted, and as shown in FIG. 10B, a TFT substrate 210 is positioned above the color filter substrate 220, and the color filter substrate 220 is positioned between the TFT substrate and the cover bottom 320. In the flip design structure, one side of the circuit film 304 is connected to the pad 310 on the pad unit 311, and then is bent along a side surface of the color filter substrate 220 to extend to the lower end of the color filter substrate 220. The other side of the circuit film 304 is connected to the driving integrated circuit 300 to be mounted on the inner surface of the cover bottom 320.

In a general display apparatus, an image is displayed externally in the direction of the color filter substrate 220, as shown in FIG. 10A, but in a display apparatus according to the present disclosure, an image is displayed externally in the direction of the TFT substrate 210, as shown in FIG. 10B.

If the TFT substrate is disposed above the color filter substrate, it is not necessary to arrange an upper cover bottom (322 of FIG. 10A) for covering the pad unit 311 or a device of the same purpose because the pads 310 provided in the pad unit 311 are not exposed to the outside.

Because the upper cover bottom can be removed through the flip design structure, the width of the bezel area can be equal to the width of the side cover bottom 321 or can be set to the minimum enough to achieve the purpose of supporting the display panel, thereby achieving the narrow bezel of the display apparatus.

However, the above-described bezel printing pattern can be provided to protect the side cover bottom 321, which is an exposed surface of the cover bottom, and the boundary of the TFT substrate 210. The bezel printing pattern forms an edge of the display area in place of the upper cover bottom 322 of FIG. 10A, and serves to prevent or reduce light leakage due to the light source behind the display area.

Also, when the upper cover bottom 322 of FIG. 10A is removed, the formation of a physical button formed on the upper cover bottom 322 in a general display apparatus structure is inevitably limited. In this case, if the bezel printing pattern and the bezel touch unit according to embodiments of the present disclosure are used, the problems can be solved.

As described above, according to aspects of the present disclosure, in the flip design structure, a bezel of the display apparatus can be formed with the bezel printing pattern in place of an upper cover bottom, and a narrow bezel of the display apparatus can be achieved by utilizing a bezel touch unit instead of a physical button.

The effects of the present disclosure described above are briefly summarized as follows.

First, according to aspects of the present disclosure, a narrow bezel of the display apparatus can be achieved through a structure in which the button key of the bezel area is removed, and the aesthetics of the display apparatus can be enhanced.

Second, aspects of the present disclosure can increase the usability of the bezel area by adding a touch function to the bezel area, which is an unused area, and the button key area can be used for other purposes.

Third, aspects of the present disclosure can have the effect of increasing touch sensing sensitivity and speeding up the feedback of the display apparatus to the user's input by using a touch sensor instead of a physical button.

Fourth, aspects of the present disclosure can solve or address problems that can occur in a display apparatus applying a flip design structure to reduce or minimize the size of the narrow bezel by using the bezel printing pattern and the bezel touch unit.

The various features according to aspects of the present disclosure described above can be briefly summarized as follows.

First, the present disclosure can receive a user's input for device control by using a bezel wiring and a bezel touch electrode instead of a conventional physical button.

Second, the bezel touch electrode in the non-display area is formed through the same process as the touch electrode in the display area, and operates by receiving the same touch driving signal from the touch driving circuit.

Third, at least one of the black matrix, the bezel printing pattern, and the polarizing plate is exposed or patterned in an area corresponding to the touch input unit.

A display apparatus according to aspects of the present disclosure can achieve a narrow bezel through a structure in which a button key of the bezel area is removed.

In addition, the aesthetics of the display apparatus can be enhanced through a new design in which a button key of the bezel area is removed.

In addition, the usability of an area can be increased by adding a touch function to the bezel area, which is an unused area.

In addition, the existing button key area can be used for other purposes.

In addition, through the implementation of functions using touch sensors in the display panel, touch sensitivity compared to physical buttons can be increased and sensing feedback can be accelerated.

The above-described feature, structure, and effect of the present disclosure are included in at least one embodiment of the present disclosure, but are not limited to only one embodiment. Furthermore, the feature, structure, and effect described in at least one embodiment of the present disclosure can be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the present disclosure.

What is claimed is:

1. A display apparatus with an integrated touch screen, the display apparatus comprising:
a display area including plurality of touch electrodes;
a non-display area adjacent to the display area and including a bezel touch unit and a plurality of bezel wirings; and
a touch driving unit configured to apply a touch driving signal to the plurality of touch electrodes,
wherein the touch driving unit applies the touch driving signal to the bezel touch unit through the plurality of bezel wirings in the non-display area.

2. The display apparatus with the integrated touch screen of claim 1, wherein the bezel touch unit includes a plurality of bezel touch electrodes, and the plurality of bezel touch electrodes include a same material as the plurality of touch electrodes.

3. The display apparatus with the integrated touch screen of claim 2, wherein the plurality of bezel touch electrodes is formed of a transparent electrode or an opaque metal mesh.

4. The display apparatus with the integrated touch screen of claim 1, wherein a bezel printing pattern is disposed in the non-display area and a touch icon pattern is disposed in the bezel printing pattern of the bezel touch unit.

5. The display apparatus with the integrated touch screen of claim 4, wherein the display area and the non-display area include a thin film transistor (TFT) substrate having a common electrode, a pixel electrode, and a TFT layer, a color filter substrate having a color filter layer and a black matrix, and a liquid crystal layer between the TFT substrate and the color filter substrate, and
the bezel printing pattern is disposed on one side of the TFT substrate.

6. The display apparatus with the integrated touch screen of claim 5, wherein the black matrix exposes the color filter substrate in an area corresponding to the bezel touch unit.

7. The display apparatus with the integrated touch screen of claim 6, wherein a multicolored pigment is patterned in an area where the color filter substrate is exposed by the black matrix.

8. The display apparatus with the integrated touch screen of claim 5, wherein the plurality of bezel wirings and the bezel touch unit are disposed on another side of the TFT substrate.

9. The display apparatus with the integrated touch screen of claim 5, further comprising:
an upper polarizing plate and a lower polarizing plate disposed on outer surfaces of the TFT substrate and the color filter substrate,
wherein one of the upper polarizing plate and the lower polarizing plate exposes a part of the TFT substrate or the color filter substrate in an area corresponding to the bezel touch unit.

10. The display apparatus with the integrated touch screen of claim 1, further comprising:
a first light source disposed on a rear surface of the display area; and
a second light source disposed in an area corresponding to the bezel touch unit in the non-display area.

11. The display apparatus with the integrated touch screen of claim 10, wherein the first light source and the second light source are different types.

12. The display apparatus with the integrated touch screen of claim 5, further comprising a cover bottom disposed under the TFT substrate and the color filter substrate,
wherein the color filter substrate is provided between the cover bottom and the TFT substrate.

13. The display apparatus with the integrated touch screen of claim 12, further comprising:
a pad connected to the TFT substrate; and
a circuit film connected to the pad and bent along a side of the color filter substrate to extend to the bottom of the color filter substrate.

14. The display apparatus with the integrated touch screen of claim 12, wherein the cover bottom includes a side cover bottom, and
the bezel printing pattern is disposed on the side cover bottom.

15. The display apparatus with the integrated touch screen of claim 14, wherein the bezel touch unit is disposed on the side cover bottom.

16. The display apparatus with the integrated touch screen of claim 4, wherein the touch icon pattern includes a plurality of touch icons each corresponding to one or more bezel touch electrodes included in the bezel touch unit.

17. The display apparatus with the integrated touch screen of claim 5, wherein the common electrode includes a plurality of common electrodes which function as the plurality of touch electrodes.

18. The display apparatus with the integrated touch screen of claim 12, wherein the display apparatus is implemented in a flip design structure.

19. The display apparatus with the integrated touch screen of claim 1, wherein the plurality of touch electrodes are connected in row or column units by a plurality of touch wirings in the display area, and simultaneously function as an element for implementing a display of the display apparatus and an element for touch recognition.

20. A display apparatus integrated with a touch screen, the display apparatus comprising:
a display area in which a plurality of pixels are disposed; and
a non-display area adjacent to the display area and including a bezel touch unit and a plurality of bezel wirings,
wherein a bezel printing pattern is formed in the non-display area and a touch icon pattern is formed in a portion of the bezel printing pattern corresponding to the bezel touch unit,
wherein the touch icon pattern includes a plurality of touch icons each corresponding to one or more bezel touch electrodes included in the bezel touch unit, and
wherein a touch driving signal is applied to the bezel touch unit through the plurality of bezel wirings in the non-display area to determine whether any one of the plurality of touch icons is touched.
